(19) United States
(12) Patent Application Publication
(10) Pub. No.: US 2006/0083219 A1
(43) Pub. Date: Apr. 20, 2006

(54) Using information about dialup access numbers in a service region to support customer service interactions

(75) Inventors: Jonathan Paden, Austin, TX (US); Bobby Sams, Austin, TX (US); Wei Li, Yorktown Heights, NY (US); Dennis Collins, Hopewell Junction, NY (US); Ed Ramos, Rye, NY (US)

Correspondence Address: AKERMAN SENTERFITT, P.O. BOX 3188, WEST PALM BEACH, FL, 33402-3188, US

(73) Assignee: SBC Knowledge Ventures, L.P., Reno, NV (US)

(21) Appl. No.: 10/965,418

(22) Filed: Oct. 14, 2004

(51) Int. Cl. H04L 12/66

(52) U.S. Cl. 370/352; 379/88.17

(57) ABSTRACT

A method for automatically providing output for a communication related to dialup Internet services. The method includes the step of determining an in-progress customer communication is related to dialup connectivity. A service region for the customer can be ascertained. A plurality of currently published dialup access numbers for the service region can be automatically fetched. For each fetched number, a status can be identified. At least one software engine automatically process the access number and status information. The at least one software engine can automatically perform at least one programmatic action resulting in output being supplied to at least one party participating in the customer communication, even though the party has not specifically requested the output.

### BACKGROUND

1. Field of the Invention

The present invention relates to the field of dial-up networking and, more particularly, to improving customer service using information relating to dialup access numbers in a service region.

2. Description of the Related Art

Dial-up Internet users access the Internet by establishing a communication link between their computer and a computing device of an Internet Service Provider (ISP). The communication link occurs across a phone line and is established when the user contacts the ISP computer device via one or more access telephone numbers. Generally, the user will be able to select one of many access number local to the user so that telephone usage charges are minimized.

It is not uncommon for dial-up users to experience problems when connecting to the Internet via an access number. One typical connectivity problem is an end user problem, meaning that the user is experiencing problems with their computer, which results in the user being unable to establish a connection with the ISP computing device. Another reason that dial-up users are unable to connect to the Internet is that the access number that the user dialed is temporarily malfunctioning.

For any given region, users have a choice of several different access numbers to dial for Internet service. When the customer contacts an ISP for a problem related to dial connectivity, there is no practical way to determine which access number (or numbers) the customer may be calling about without requesting the information from the caller. Many callers may be inexperienced users that have difficulty determining the access number with which they are experiencing problems. Time delays spent waiting for users to locate access numbers can be substantial, resulting in increased times spent by each live agent per call. These delays can result in increased wait times for other customers. What is needed is a means through which customers, contact center agents, and/or automated voice response systems can interact without incurring the delay time associated with customers determining a problematic access number, which conventionally are required by the automated voice response system or contact center agent in order to support a customer.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a system that uses information about dialup access numbers in a service region to support customer service interactions in accordance with one embodiment of the invention.

FIG. 2 is a graphical user interface that presents information about dialup access numbers in a service region in accordance with one embodiment of the invention.

FIG. 3 is a flow chart illustrating a method for using information about dialup access numbers in a service region to support customer service interactions in accordance with one embodiment of the invention.

### DETAILED DESCRIPTION OF THE INVENTION

The present invention discloses a system, a method, and an apparatus for improving customer service using information about dialup access numbers in a service region. The invention can include a software engine configured to determine a likelihood that a communication concerns a dialup access problem. When this likelihood exceeds a previously determined threshold, one or more programmatic actions can execute. For example, one of the programmatic actions can detect a service region (possibly using automatic number information extracted from the communication) for a particular ISP subscriber participating in the communication and can determine the access numbers and corresponding operational status for each access number in the service region. Another programmatic action can present the determined access numbers and statuses to a communication participant, such as an ISP subscriber, an IVR, or a customer service agent.

The output can aid the output recipient during a customer service communication. For example, when a customer service agent is presented with information showing all access numbers in a caller's service region are operational, the customer service agent need not know the customer's access number to respond to a customer's problem, as it can be assumed that the customer is most likely experiencing an end-user problem. When the customer service agent is presented with information showing all access numbers in the caller's service region are out of service, the agent can assume a customer's problem is caused by a network flaw. When the customer service agent is presented with data showing some access numbers in the designated area are operational and others are not, the agent can present operational access numbers to the caller in an attempt to resolve the customer's problem.

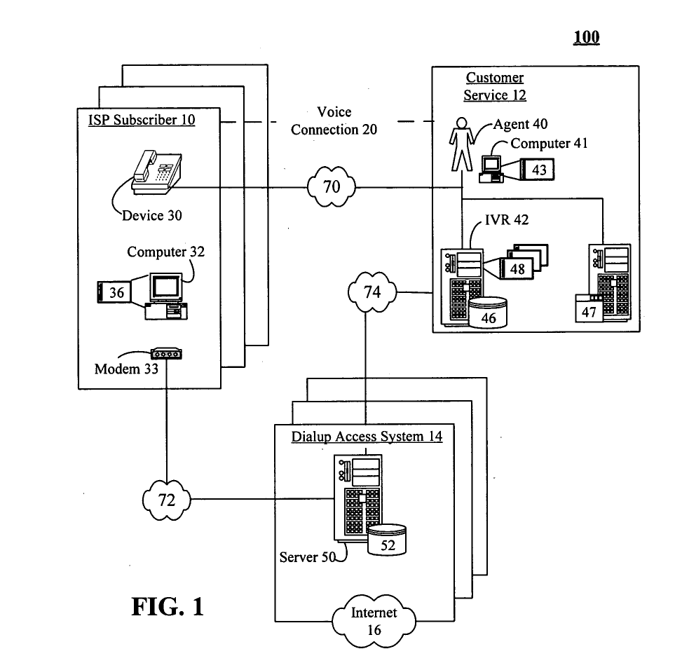

FIG. 1 is a schematic diagram illustrating a system 100 that uses information about dialup access numbers in a service region to support customer service interactions in accordance with one embodiment of the invention. The system 100 can include ISP subscribers 10, a customer service center 12, and a dialup access system 14. The dialup access system 14 can grant Internet 16 access to the ISP subscribers 10. Typically, a computer 32 attached to a modem 33 will communicatively link to a server 50 across network 72. The server 50 will provide one or more ports to the Internet 16 that are associated with one or more dialup access numbers. The dialup access number can determine the port though which the ISP subscriber 10 is connected to the Internet 16. The dialup access system 14 can provide several different access numbers local to the ISP Subscriber 10. Dialup account information contained in data store 52 can be used to authorize the ISP subscriber 10.

The customer service center 12 can receive ISP subscriber 10 calls pertaining to dialup services and can help the ISP subscriber 10 establish dial-up service. Support functions of the customer service center 12 can be handled using one or more live agents 40 and/or an Interactive Voice Response system 42. The live agents 40 and the IVR 42 can utilize data supplied by data store 46 when interacting with an ISP subscriber 10. Data store 46 can include customer specific data, network specific data, service specific data, historical data, or the like. Interface 48 can be designed to permit the IVR 42 to interface with ISP Subscriber 10 or agent 40. The agent 40 can also be provided with a computer 41, which is part of a customer support information system. The computer 41 can include a graphical user interface 43, though which the agent 40 can interact.

The customer service center 12 can also include a software engine 47, which can be hosted on a server of the customer service center 12. The software engine 47 can situationally provide the agent 40, the IVR 42, and/or the ISP Subscriber 10 with information concerning access numbers within the service region of the ISP subscriber 10.

To illustrate by example, a voice connection 20 can be established between the ISP subscriber 10 and the customer service center 12. Automatic number identification (ANI) information can be extracted from the voice connection 20 and sent to the software engine 47. The software engine 47 can determine a service region associated with the calling number. The software engine 47 can then access the dialup access system 14 to fetch a list of access numbers in the service region as well as additional information about each access number. This information can be used to support the voice connection 20 in various manners.

For example, the information can be used by IVR 42 to predict that the ISP Subscriber 10 is attempting to report a dialup problem. The IVR 42 can responsively prompt the ISP subscriber 10 for input as to whether the ISP subscriber 10 is experiencing dialup problems. Such reactive prompting can speed up telephone communications with the IVR 42.

In another example, the information can be supplied to interface 43 of computer 41, which the agent 40 can use. This data conveyance can occur over a data communication link, while the voice connection 20 is in-progress. The agent 40 can use this information to expedite telephone calls with the ISP subscriber 10.

In still another example, the information can be presented to the ISP subscriber 10 directly. The information can be visually presented upon an interface 36 of computer 32 or can be audibly presented using device 30.

The customer service center 12 can be linked to the dialup access center 14 through network 74. Information in data store 46 and 52 can be shared across this link. Additionally, once the ISP Subscriber 10 is connected to the Dial Access System 14, client based routines and data within computer 32 can be accessed by the IVR 42, computer 41, and server 50 across network 72 and 74 as needed assuming proper authorization is provided.

As used herein, voice link 20 can be a standard public switched telephone network (PSTN) connection, which is typically a circuit-switched connection. The voice link 20 is not limited in this regard, however, and a packet-based connection that utilizes a technology like Voice over Internet Protocol (VoIP) can also form the voice link 20.

Networks 70, 72, 74, and 16 can be implemented as any of a variety of fashions so long as content is conveyed using encoded electromagnetic signals. Further, any of a variety of communication devices, such as customer premise equipment (CPE), computers, modems, routers, switches, or the like, can be included within networks 70, 72, 74, and 16.

Each of the networks 70, 72, 74, and 16 can convey content in a packet-based or circuit-based manner. Additionally, each of the networks 70, 72, 74, and 16 can convey content via landlines or wireless data communication methods. For example, each of the networks 70, 72, 74, and 16 can separately include an Intranet, a local area network, a wide area network, or a combination thereof. In another example, each of the networks 70, 72, 74, and 16 can include a telephony network, like a mobile wireless network or a public switched telephone network (PSTN).

The data stores 46 and 52 can store information in any recording medium, such as a magnetic disk, an optical disk, a semiconductor memory, or the like. Further, each of the data stores 46 and 52 can utilize any information retention technique including a file-based storage technique or a database storage technique. Moreover, each of the data stores 46 and 52 can be a storage area fixed to a geographical location or a storage area distributed across a network space.

It should be appreciated that the arrangements shown in FIG. 1 are for illustrative purposes only and that the invention is not limited in this regard. The functionality attributable to the various components can be combined or separated in different manners than those illustrated herein. For instance, the dialup access system 14 can be integrated with the customer service center 12 in one embodiment of the invention disclosed herein.

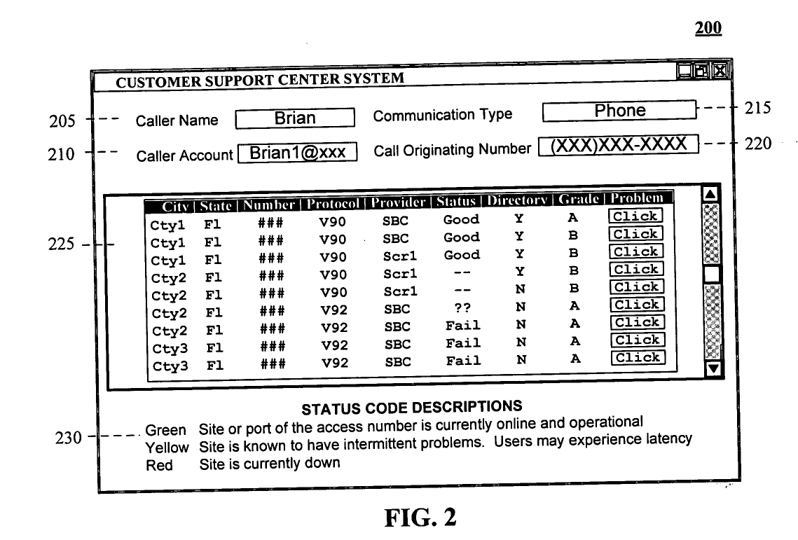

FIG. 2 is a graphical user interface 200 that presents information about dialup access numbers in a service region in accordance with one embodiment of the invention. In one embodiment the graphical user interface (GUI) 200 can receive output provided by the software engine 47 of system 100. As such, GUI 200 can represent interface 43 or interface 36 shown in system 100.

GUI 200 can display a caller name 205, a caller account 210, a communication type 215, and a call originating number 220. The caller name 205 can specify that the name of a caller currently participating in a customer support communication session, supported by GUI 200. The caller account 210 can be an access account through which the named caller receives dialup service. The communication type 215 can indicate the type of communication session that GUI 200 supports. Communication types can include, but are not limited to, phone communications, chat communications, instant message communications, teleconferencing, co-browsing sessions, and the like. The call originating number 220 can display the number (assuming the supported communication is a phone communication) of an ongoing communication. In one embodiment, the call originating number 220 can be replaced by or supplemented with a service region field (not shown).

GUI 200 can present a table 225 of dialup access numbers within the same service region as the call originating number 220. For each dialup access number, values for an associated city, state, number, protocol, provider, status, directory, and grade can be included. A problem reporting button can also be included, the selection of which enables the user of GUI 200 to report a problem with the associated access number.

In one embodiment, each access number displayed in table 225 can be color coded to indicate an operational status of the access number. For example, as shown by description 230, green can indicate an access number is online and operational. Yellow can indicate the access number is known to have intermittent problems and should not be used if an alternative access number is a available. Red can indicate that the access number is currently down or out of operation.

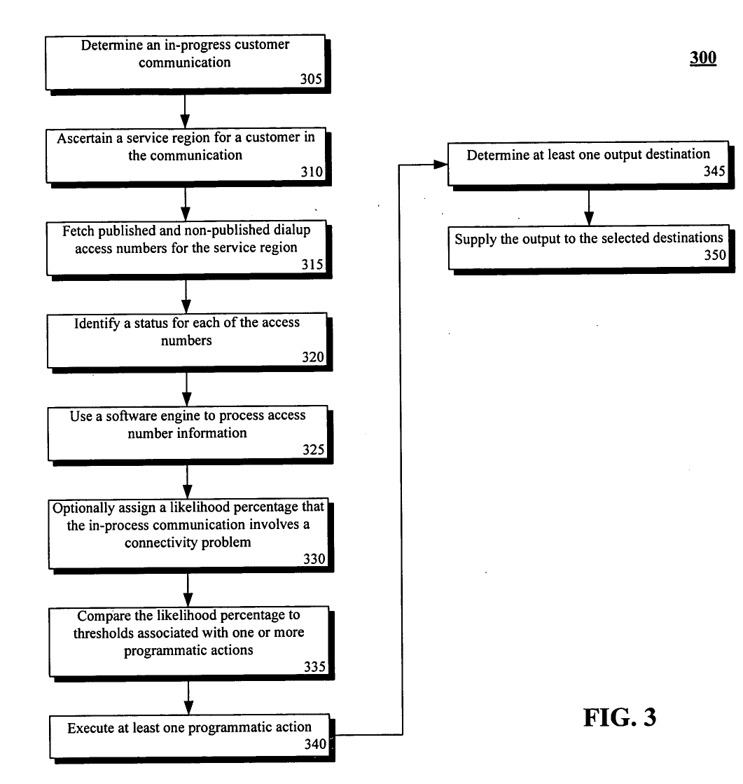

FIG. 3 is a flow chart illustrating a method 300 for using information about dialup access numbers in a service region to support customer service interactions in accordance with one embodiment of the invention. The method 300 can be performed in the context of any of a variety of automated systems where ISP subscribers are provided with support. In one embodiment, the method 300 can be performed in the context of a customer support system, such as system 100. In another embodiment, the method 300 can display output upon a GUI, such as GUI 200.

The method 300 can begin in step 305, where an in-process customer communication can be detected. This communication can, for example, be a telephone communication between a ISP subscriber and an IVR or customer service agent. In step 310, a service region for the ISP subscriber can be ascertained. This service region can be the region containing access numbers local to the ISP subscriber. In step 315, published and non-published dialup access numbers can be fetched for the service region. Published numbers include those access numbers that are typically presented to ISP subscribers. Non-published dialup access numbers can include additional access numbers that can be used within the service region. Non-published dialup access numbers can, for example, include access numbers provided by third party supplies that an ISP can contractually utilize when necessary.

In step 320, an operational status for each of the access numbers can be identified. This identification can include interrogating ports within the ISP infrastructure associated with the access numbers to obtain a current operational status. In step 325, a software engine can be used to process access number information. Step 330 represents one of the processes that can be performed by the software engine.

In step 330, the software engine can determine by processing the access number information a likelihood that the in-process communication involves a connectivity problem. In step 335, the likelihood percentage can be compared to one or more threshold values. Each threshold value can be associated with one or more programmatic actions, triggered when the threshold is exceeded.

For example, when many access numbers in the service region from which the caller is calling are out of service, there can be a high likelihood that the in-process communication relates to a connectivity problem. Consequently, when a previously established likelihood threshold is exceeded, an IVR (involved in the in-process communication) can preemptively ask the calling ISP subscriber if the subscriber is experiencing a connectivity problem.

It should be appreciated that when many access numbers in the service region from which the caller is calling are in service, there can be a low likelihood that the in-progress communication relates to a network-caused connectivity problem. Consequently, when a caller informs an IVR (involved in the in-process communication) that the caller is having problems connecting to the ISP provider, the IVR can present messages designed to identify and ameliorate an end-user problem.

In step 340, the programmatic actions associated with exceeded thresholds can be executed. In step 345, at least one destination for output generated by the programmatic actions can be determined. Destinations can include a customer support agent computer, an ISP subscriber computer, an IVR interface, and combinations thereof. In step 350, the output can be supplied to the selected destinations. For example, when the output is supplied to a GUI like GUI 200, the GUI can present the output information, thereby facilitating the customer support communication already in progress.

It should be appreciated that the steps detailed within method 300 represent one illustrative embodiment of the inventive arrangements disclosed herein. The scope of the invention is to be construed as including adaptive deviations of the method 300 that are essentially the same as steps detailed herein.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for automatically providing output for a communication related to dialup Internet services comprising the steps of:
determining an in-progress customer communication is related to dialup connectivity;
ascertaining a service region for a customer corresponding to the customer communication;
automatically fetching a plurality of currently published dialup access numbers for the service region;
responsive to the fetching step, automatically identifying a status for each of the fetched dialup access numbers;
automatically processing information returned by the fetching and identifying steps within at least one software engine; and
responsive to the processing step, automatically performing at least one programmatic action resulting in output being automatically supplied to at least one party participating in the customer communication, wherein the party has not specifically requested that the output be provided.

2. The method of claim 1, wherein the in-progress customer communication includes a voice communication link between the customer and a customer service agent and includes a data communication link between the at least one software engine and a computing device used by the party to whom the output is supplied.

3. The method of claim 2, wherein the at least one party includes the customer.

4. The method of claim 2, wherein the at least one party includes the customer service agent.

5. The method of claim 2, wherein the at least one party includes the customer and the customer service agent.

6. The method of claim 1, wherein the party supplied with the output is the customer, and wherein the in-progress customer communication includes a data communication link between the at least one software engine and the customer, the output being supplied to a computing device that the customer is using, where the at least one software engine is remotely located from the computing device.

7. The method of claim 1, wherein the output is presented within a graphical user interface of a customer service agent, wherein the in-progress customer communication is between the customer and the customer service agent.

8. The method of claim 7, wherein the in-process communication includes a voice communication link involving the customer, and wherein ascertaining step is performed based upon input provided by the customer to an automated voice system, the method further comprising the step of:
transferring the voice communication link from the automated voice response system to the customer service agent.

9. The method of claim 7, wherein the output presented within the graphical user interface includes display elements showing each of the fetched dialup access numbers and associated status indicators.

10. The method of claim 9, wherein the graphical user interface further includes display elements showing a grade and a protocol for each presented dialup access number.

11. The method of claim 9, wherein the graphical user interface further includes display elements showing a city an a provider for each presented dialup access number.

12. The method of claim 9, wherein the display items are color coded by access number with different colors representing different operational states of the access numbers.

13. The method of claim 9, wherein the graphical user interface includes a display item for reporting a problem with an associated dialup access number, the selection of which initiates a problem reporting process.

14. The method of claim 1, further comprising the steps of:
automatically fetching a plurality of non-published dialup access numbers for the service region; and
automatically identifying a status for each of the fetched non-published dialup access numbers, wherein processing performed by the at least one software engine utilizes the fetched non-published dialup access numbers and associated status information.

15. The method of claim 1, the automatically processing step further comprising the step of:
assigning a likelihood percentage that the in-process customer communication involves a connectivity problem, wherein the likelihood percentage determines whether one of the at least one programmatic action is to be automatically performed.

16. The method of claim 1, wherein the at least one programmatic action is a problem reporting action configured to enable the customer to report a problem with a customer specified access number.

17. A machine-readable storage having stored thereon, a computer program having a plurality of code sections, said code sections executable by a machine for causing the machine to perform the steps of:
determining an in-progress customer communication is related to dialup connectivity;
ascertaining a service region for a customer corresponding to the customer communication;
automatically fetching a plurality of currently published dialup access numbers for the service region;
responsive to the fetching step, automatically identifying a status for each of the fetched dialup access numbers;
automatically processing information returned by the fetching and identifying steps within at least one software engine; and
responsive to the processing step, automatically performing at least one programmatic action resulting in output being automatically supplied to at least one party participating in the customer communication, wherein the party has not specifically requested that the output be provided.

18. A system for supporting customers of dialup internet services comprising:
a software engine disposed within a back-end component of a customer support information system that is configured to determine a likelihood that an in-progress customer communication involves a connectivity problem based upon operational status of a plurality of access numbers in a service region for an Internet service provider subscriber corresponding to the customer communication, wherein the software engine is further configured to automatically execute at least one programmatic action resulting in output that is supplied to at least one party participating in the in-progress customer communication, and wherein the automatic execution of the at least one programmatic action is dependant upon the determined likelihood.

19. The system of claim 18, further comprising:
an agent graphical user interface for presenting the output of the software engine to a customer support agent, wherein the in-process customer communication is a voice communication between the customer support agent and the Internet service provider subscriber, wherein the agent graphical user interface is a front-end component paired to the backend component in which the software engine is disposed.

20. The system of claim 18, further comprising:
an interactive voice response system acting as a party to the in-process customer communication that presents the output to the Internet service provider subscriber, wherein the interactive voice response system includes a front-end component paired to the backend component in which the software engine is disposed.
